(19) United States
(12) Patent Application Publication
(10) Pub. No.: US 2026/0326484 A1
(43) Pub. Date: Oct. 22, 2026

(54) TIRE

(71) Applicant: The Yokohama Rubber Co., LTD., Kanagawa (JP)

(72) Inventor: Taiyo MORI, Kanagawa (JP)

(21) Appl. No.: 19/539,930

(22) Filed: Feb. 13, 2026

(30) Foreign Application Priority Data
Feb. 18, 2025 (JP) 2025-023885

(51) Int. Cl. B60C 9/20; B60C 11/01; B60C 11/03

(52) U.S. Cl. CPC B60C 9/20; B60C 9/2006; B60C 11/01; B60C 11/0332; B60C 2009/2083

(57) ABSTRACT

A tire includes a belt layer having a pair of cross belt layers and a circumferential reinforcing layer between the cross belt layers, formed with a width in the width direction narrower than a width of the cross belt layers and having a belt cord inclination angle in the width direction relative to the tire circumferential direction of 5° or less. In the tread portion, a shoulder portion lateral side groove extends in the circumferential direction is disposed on a shoulder portion lateral side surface, which is a side surface of the tread portion in the width direction, and a development width W₀ of a tread ground contact surface and a distance W₁ between an end portion of the circumferential reinforcing layer and a groove bottom of the shoulder portion lateral side groove satisfy 0.06×W₀≤W₁≤0.28×W₀.

### CROSS-REFERENCE TO RELATED APPLICATIONS

This application is the U.S. national stage application filed pursuant to 35 U.S.C. 365(c) and 120 as a continuation of Japanese Patent Application No. 2025-023885, filed Feb. 18, 2025, the entire contents of which is incorporated herein by reference.

### TECHNICAL FIELD

The present technology relates to a tire.

### BACKGROUND ART

A tire has a belt layer as a reinforcing layer in a tread portion. The tread portion has increased rigidity due to the belt layer, and performance of known tires has been improved by devising the belt layer. For example, the tire described in Japan Unexamined Patent Publication No. 2010-208502 A is a tire including a circumferential belt disposed on a radially outer side of a crown portion of a carcass, and tread rubber covering the crown portion of the carcass and the circumferential belt, in which narrow grooves extending toward an inner side in the radial direction are formed in a surface layer portion of the tread rubber located on an outer side in the tire width direction from width-direction edges of the circumferential belt. Additionally, in the tire described in Japan Unexamined Patent Publication No. H10-250314 A, a belt includes two or more cord crossing layers near a carcass and two or more substantially inextensible circumferentially arranged cord layers on an outer circumferential side thereof.

Here, in a tire used under a long-haul operation mainly involving high-speed continuous traveling, the tire cannot be used until the end of its service life due to the occurrence of uneven wear, and the tire may need to be removed and replaced at an early stage before the service life. As a method for improving the uneven wear resistance of such tires, for example, arranging grooves on the outer side in the tire width direction of the development width of the tread portion to reduce ground contact pressure near the shoulder end portion, thereby improving shoulder uneven wear, can be cited.

However, when grooves are arranged on the outer side of the development width of the tread portion, while improvement in shoulder uneven wear can be expected, cracks may occur at the groove bottom. Therefore, it has been difficult to suppress the occurrence of cracks in grooves arranged on the outer side of the development width of the tread portion for improving shoulder uneven wear while also reducing shoulder uneven wear.

### SUMMARY

The present technology provides a tire that can provide improved crack resistance and uneven wear resistance in a well-balanced manner.

A tire according to the present technology includes a belt layer that is disposed in a tread portion and includes a plurality of belt plies, in which the belt layer includes a pair of cross belt layers in which inclination directions of belt cords in a tire width direction relative to a tire circumferential direction are opposite to each other, and a circumferential reinforcing layer disposed between the pair of cross belt layers, formed with a width in the tire width direction narrower than a width of the cross belt layers, and having a belt cord inclination angle in the tire width direction relative to the tire circumferential direction of 5° or less, in the tread portion, a shoulder portion lateral side groove extending in the tire circumferential direction is disposed on a shoulder portion lateral side surface, the shoulder portion lateral side surface being a side surface of the tread portion in the tire width direction, and when a development width of a tread ground contact surface of the tread portion is denoted as W₀ and a distance between an end portion of the circumferential reinforcing layer in the tire width direction and a groove bottom of the shoulder portion lateral side groove is denoted as W₁, the development width W₀ and the distance W₁ satisfy a relationship of 0.06×W₀≤W₁≤0.28×W₀.

The tire according to the present technology achieves the effect that can provide improved crack resistance and uneven wear resistance in a well-balanced manner.

### BRIEF DESCRIPTION OF DRAWINGS

FIG. 1 is a tire meridian cross-sectional view illustrating a main portion of a pneumatic tire according to an embodiment.

FIG. 2 is a schematic diagram illustrating a belt layer illustrated in FIG. 1.

FIG. 3 is a detailed view of a tread portion illustrating a region on one side from a tire equatorial plane in a tire width direction of the tread portion illustrated in FIG. 1.

FIG. 4 is a detailed view of a shoulder portion lateral side groove illustrated in FIG. 3.

FIG. 5 is an explanatory diagram showing the positional relationship between cross belt layers of the belt layer and a shoulder portion lateral side groove.

FIG. 6A is a table indicating results of performance evaluation tests of pneumatic tires.

FIG. 6B is a table indicating results of performance evaluation tests of the pneumatic tires.

FIG. 6C is a table indicating results of performance evaluation tests of the pneumatic tires.

### DETAILED DESCRIPTION

An embodiment according to the present technology will be described in detail below with reference to the drawings. However, the technology is not limited to the embodiment. Constituents of the embodiment include elements that are substitutable while maintaining consistency with the technology and obviously substitutable elements. The plurality of modified examples described in the embodiment can be combined as desired within the scope apparent to one skilled in the art.

### Embodiments

In the following description, a description will be given using a pneumatic tire 1 as an example of the tire according to the embodiments of the present technology. The pneumatic tire 1 as an example of the tire can be inflated with any gas including air and inert gas, such as nitrogen.

In the following description, the term “tire radial direction” refers to a direction orthogonal to the tire rotation axis (not illustrated), which is a rotation axis of a pneumatic tire 1, the term “inner side in the tire radial direction” refers to a side toward the tire rotation axis in the tire radial direction, and the term “outer side in the tire radial direction” refers to a side away from the tire rotation axis in the tire radial direction of an embodiment. The term “tire circumferential direction” refers to a circumferential direction with the tire rotation axis as a center axis. The term “tire width direction” refers to a direction parallel with the tire rotation axis, the term “inner side in the tire width direction” refers to a side toward a tire equatorial plane (tire equator line) CL in the tire width direction, and the term “outer side in the tire width direction” refers to a side away from the tire equatorial plane CL in the tire width direction. The term “tire equatorial plane CL” refers to a plane that is orthogonal to the tire rotation axis and that runs through the center of the tire width of the pneumatic tire 1. The tire equatorial plane CL aligns, in a position in the tire width direction, with a center line in the tire width direction corresponding to a center position of the pneumatic tire 1 in the tire width direction. The term “tire equator line” refers to a line in the tire circumferential direction of the pneumatic tire 1 that lies on the tire equatorial plane CL. The term “cross-section in the tire meridian direction (meridian cross-sectional view)” refers to a cross section of the tire taken along a plane that includes the tire rotation axis.

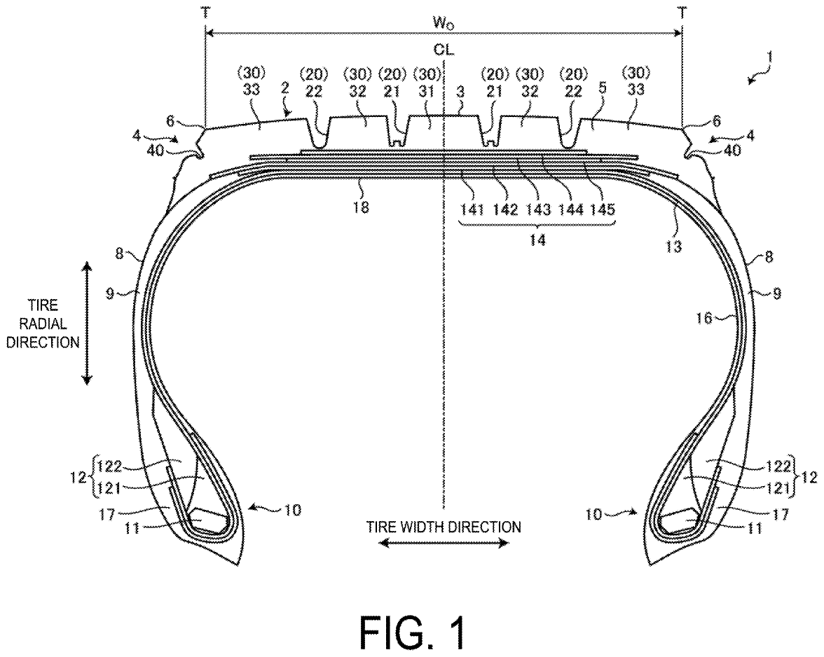

FIG. 1 is a tire meridian cross-sectional view illustrating a main portion of the pneumatic tire 1 according to an embodiment. FIG. 1 illustrates a meridional cross section of the pneumatic tire 1 according to an embodiment, the cross section of one side region of a tire rotation axis in a tire radial direction. In the present embodiment, a heavy duty pneumatic radial tire mounted on a long-distance transport vehicle such as a truck or bus will be described as an example.

In the pneumatic tire 1 according to the present embodiment, a tread portion 2 is disposed on a portion on the outermost side in the tire radial direction when viewed in a tire meridian cross-section, and the tread portion 2 includes a tread rubber 5 made of a rubber composition. A surface of the tread portion 2, that is, a portion that comes into contact with road surfaces during traveling of a vehicle (not illustrated) on which the pneumatic tires 1 are mounted is formed as a tread ground contact surface 3, and the tread ground contact surface 3 forms a portion of a contour of the pneumatic tire 1.

At least two or more circumferential main grooves 20 extending in the tire circumferential direction are disposed in the tread ground contact surface 3 in the tread portion 2, and a plurality of land portions 30 are defined by the plurality of circumferential main grooves 20 on the surface of the tread portion 2. In the present embodiment, the circumferential main grooves 20 include two center main grooves 21 disposed on both sides of the tire equatorial plane CL in the tire width direction with the tire equatorial plane CL interposed therebetween, and two shoulder main grooves 22, each disposed on the outer side in the tire width direction of each of the two center main grooves 21, totaling four grooves.

The circumferential main groove 20 referred to herein is a groove being a longitudinal groove extending in the tire circumferential direction and internally having a wear indicator (slip sign) indicative of terminal stages of wear. The circumferential main grooves 20 formed in the above-described manner have a groove width within a range of 5.0 mm or more and 25.0 mm or less, and a groove depth within a range of 5.0 mm or more and 30.0 mm or less.

The land portion 30 defined by the circumferential main groove 20 includes a center land portion 31, middle land portions 32, and shoulder land portions 33. Of these, the center land portion 31 is a land portion 30 located between the center main grooves 21, with both sides in the tire width direction being defined by the center main grooves 21. The middle land portion 32 is a land portion 30 located between the center main groove 21 and the shoulder main groove 22 adjacent to each other in the tire width direction, the land portion 30 having both sides in the tire width direction being defined by the center main groove 21 and the shoulder main groove 22. In other words, the middle land portion 32 has its inner side in the tire width direction defined by the center main groove 21 and its outer side in the tire width direction defined by the shoulder main groove 22. The shoulder land portion 33 is a land portion 30 located on the outer side in the tire width direction of the shoulder main groove 22, with its inner side in the tire width direction being defined by the shoulder main groove 22. Also, the middle land portions 32 and the shoulder land portions 33 are disposed on both sides of the tire equatorial plane CL in the tire width direction.

Shoulder portions 6 are located at both outer ends in the tire width direction of the tread portion 2 formed as described above, and a sidewall portion 8 is disposed on the inner side in the tire radial direction of the shoulder portion 6. In other words, the sidewall portions 8 are disposed on both sides in the tire width direction of the tread portion 2. In other words, the sidewall portions 8 are disposed at two sections on both sides in the tire width direction of the pneumatic tire 1 and form portions exposed to the outermost sides in the tire width direction of the pneumatic tire 1. The sidewall portion 8 includes a sidewall rubber 9 made of a rubber composition.

A bead portion 10 is provided on an inner side in the tire radial direction of each of the sidewall portions 8 located on both sides in the tire width direction. Similarly to the sidewall portions 8, the bead portions 10 are disposed at two sections on both sides of the tire equatorial plane CL. That is, a pair of the bead portions 10 is disposed on both sides in the tire width direction of the tire equatorial plane CL. The bead portions 10 each include a bead core 11, and a bead filler 12 is provided on an outer side in the tire radial direction of the bead core 11.

The bead core 11 is an annular member formed in an annular shape by bundling bead wires, which are steel wires, and winding them multiple times. The bead fillers 12 include a lower filler 121 and an upper filler 122, which are rubber members, are respectively disposed on outer sides in the tire radial direction of the bead cores 11, and reinforce the bead portions 10.

A carcass layer 13 containing cords of radial plies is continuously provided on an inner side in the tire radial direction of the tread portion 2 and on a tire equatorial plane CL side of the sidewall portions 8. Accordingly, the pneumatic tire 1 according to the present embodiment is configured as a so-called radial tire. The carcass layer 13 has a single layer structure made of one carcass ply or a multilayer structure made of a plurality of carcass plies layered, and spans between the pair of bead portions 10 disposed on both sides in the tire width direction in a toroidal shape to form a framework of the tire.

Specifically, the carcass layer 13 is disposed to span from one bead portion 10 to the other bead portion 10 of the pair of bead portions 10 located on both sides in the tire width direction and is turned back toward the outer side in the tire width direction along the bead cores 11 at the bead portions 10 so as to wrap around the bead cores 11 and the bead fillers 12. The bead filler 12 is a rubber member disposed in a space on the outer side in the tire radial direction of the bead core 11, the space being formed by folding the carcass layer 13 back at the bead portion 10. The carcass ply of the carcass layer 13 is made by coating, with coating rubber, and rolling a plurality of carcass cords made of steel or an organic fiber material such as aramid, nylon, polyester, or rayon. The plurality of carcass cords forming the carcass ply are disposed in parallel at an angle in the tire circumferential direction, the angle with respect to the tire circumferential direction being along a tire meridian direction.

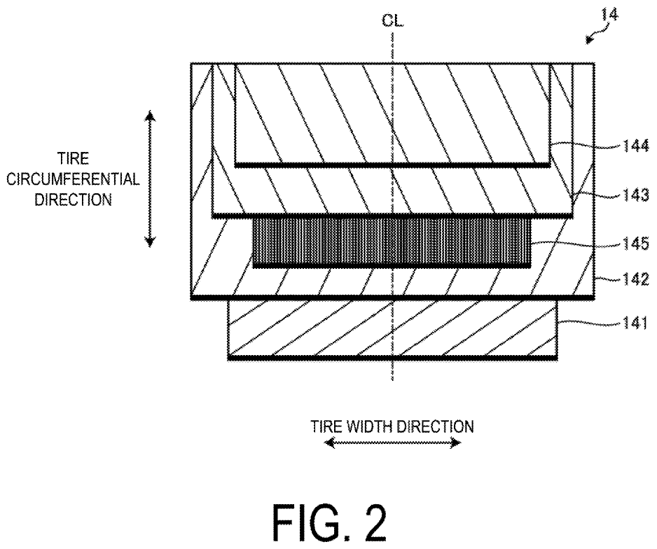

A belt layer 14 is disposed in the tread portion 2. FIG. 2 is a schematic diagram illustrating the belt layer 14 illustrated in FIG. 1. The belt layer 14 is disposed on the outer side in the tire radial direction of a portion, located in the tread portion 2, of the carcass layer 13 spanning between the pair of bead portions 10. The belt layer 14 is formed by layering a plurality of belt plies 141 to 145 and is disposed around an outer circumference of the carcass layer 13. The belt plies 141 to 145 include a large-angle belt layer 141, a pair of cross belt layers 142 and 143, a belt cover 144, and a circumferential reinforcing layer 145.

The large-angle belt layer 141 is formed by covering a plurality of belt cords made of steel wire with a coating rubber and performing a rolling process thereon and has a cord angle (defined as an inclination angle in a longitudinal direction of the belt cord with respect to the tire circumferential direction) of 45° or more and 70° or less, preferably 54° or more and 68° or less as an absolute value. The large-angle belt layer 141 is disposed in a layered manner on an outer side in the tire radial direction of the carcass layer 13.

The pair of cross belt layers 142 and 143 are constituted by coating a plurality of belt cords made of steel wires with coating rubber and rolling them, and have a cord angle (defined as the inclination angle of the longitudinal direction of the belt cords relative to the tire circumferential direction) in the range of 10° to 70° in absolute value, preferably 10° to 45°, and more preferably 14° to 28°. The pair of cross belt layers 142 and 143 have cord angles having mutually opposite signs and is layered by making the belt cords mutually intersect in the longitudinal direction of the belt cords (a so-called crossply structure is formed). That is, inclination directions of the belt cords of the pair of cross belt layers 142 and 143, toward the tire width direction with respect to the tire circumferential direction, are opposite to each other. The pair of cross belt layers 142 and 143 are disposed in a layered manner on an outer side in the tire radial direction of the large-angle belt layer 141. Here, the cross belt layer 142 located on the inner side in the tire radial direction is defined as an inner cross belt layer, and the cross belt layer 143 located on the outer side in the tire radial direction is defined as an outer cross belt layer.

The belt cover 144 is formed by covering a plurality of belt cover cords made of steel wire or organic fiber material with a coating rubber and performing a rolling process thereon, and has a cord angle of 10° or more and 45° or less, preferably 14° or more and 28° or less as an absolute value. The belt cover 144 is disposed in a layered manner on an outer side in the tire radial direction of the cross belt layers 142 and 143. In the present embodiment, the belt cover 144 has the same cord angle as the outer cross belt layer 143 and is disposed in the outermost layer of the belt layer 14.

The circumferential reinforcing layer 145 is made by spirally winding a belt cord made of steel wire covered with a coating rubber in the tire circumferential direction, and has a cord angle of 5° or less as an absolute value. That is, an inclination angle of the belt cord of the circumferential reinforcing layer 145 toward the tire width direction with respect to the tire circumferential direction is 5° or less. The circumferential reinforcing layer 145 is disposed between the pair of cross belt layers 142 and 143. The circumferential reinforcing layer 145 is formed with a width in the tire width direction that is narrower than widths of the cross belt layers 142 and 143 in the tire width direction. Therefore, the circumferential reinforcing layer 145 is disposed on an inner side in the tire width direction of end portions on both sides in the tire width direction of the pair of cross belt layers 142 and 143. Specifically, the circumferential reinforcing layer 145 is formed by spirally winding one or a plurality of wires on the outer circumference of the inner cross belt layer 142. The circumferential reinforcing layer 145 is continuously disposed in the tire width direction so as to go across the tire equatorial plane CL in the tire width direction.

In the present embodiment, the circumferential reinforcing layer 145 has a number of ends of the belt cords, that is, a number of the belt cords per unit width, within a range of 15 ends per 50 mm or more and 30 ends per 50 mm or less. An outer diameter of the belt cord is within a range of 1.2 mm or more and 2.2 mm or less. In a configuration in which the belt cords are made of a plurality of cords twisted together, a diameter of a circle that circumscribes the belt cord is measured as the outer diameter of the belt cord.

At the bead portion 10, a rim cushion rubber 17 that forms a contact surface of the bead portion 10 with respect to a rim flange is disposed on the inner side in the tire radial direction and the outer side in the tire width direction of the bead core 11 and a turned back portion of the carcass layer 13. An innerliner 16 is formed along the carcass layer 13 on the inner side of the carcass layer 13 or on the inner portion side of the carcass layer 13 in the pneumatic tire 1. The innerliner 16 forms a tire inner surface 18 that is a surface on the inner side of the pneumatic tire 1.

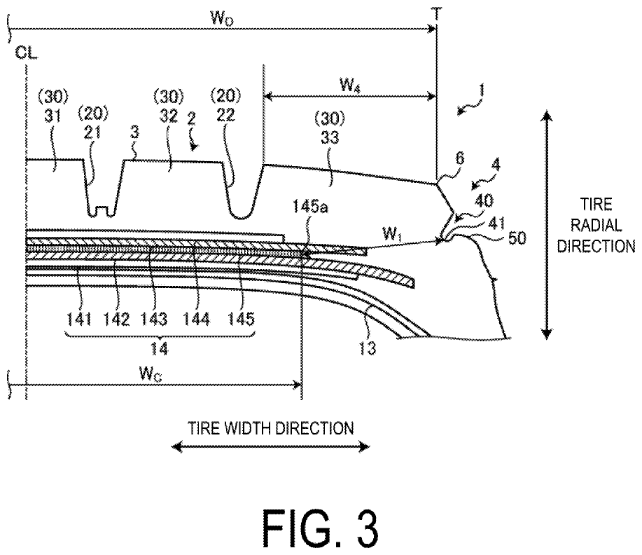

FIG. 3 is a detailed view of the tread portion 2 illustrating a region on one side from the tire equatorial plane CL in the tire width direction of the tread portion 2 illustrated in FIG. 1. The tread portion 2 is provided with a shoulder portion lateral side groove 40, which is a narrow groove extending in the tire circumferential direction, disposed on the shoulder portion lateral side surface 4, which is a side surface of the tread portion 2 in the tire width direction. The shoulder portion lateral side surface 4 referred to herein is located on an outer side of the tread ground contact surface 3 in the contour shape of the tread portion 2 in a tire meridian cross-section, and is positioned on the inner side in the tire radial direction of the shoulder portion 6 and on the outer side in the tire radial direction of the sidewall portion 8.

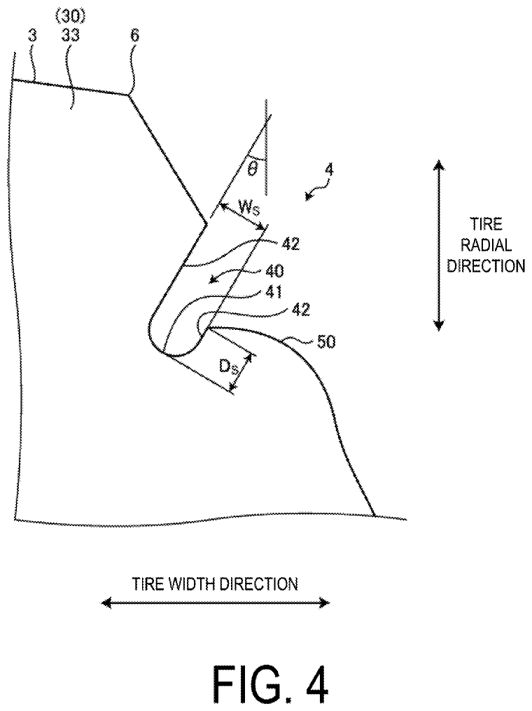

FIG. 4 is a detailed view of the shoulder portion lateral side groove 40 illustrated in FIG. 3. The shoulder portion lateral side groove 40 is formed to be inclined with respect to the tire radial direction such that it extends toward the inner side in the tire width direction as it progresses toward the inner side in the tire radial direction from the surface of the shoulder portion lateral side surface 4. Specifically, in the shoulder portion lateral side groove 40, the angle θ with respect to the tire radial direction of the groove wall 42 located on the inner side in the tire width direction among the opposing groove walls 42 of the shoulder portion lateral side groove 40, i.e., the groove wall 42 located on the shoulder portion 6 side, is within the range of 0°≤θ≤50°.

By forming the shoulder portion lateral side groove 40 on the shoulder portion lateral side surface 4 as described above, a non-contact rib 50 is provided on the outer side in the tire width direction of the shoulder portion lateral side groove 40, i.e., on the portion opposite to the side where the shoulder portion 6 is located with respect to the shoulder portion lateral side groove 40. The non-contact rib 50 is formed to extend in the tire circumferential direction, with its portion on the shoulder portion lateral side groove 40 side being defined by the shoulder portion lateral side groove 40.

The shoulder portion lateral side groove 40 disposed on the shoulder portion lateral side surface 4 has a groove width Ws in the range of 0.5 mm to 4.0 mm and a groove depth Ds in the range of 1.0 mm to 8.0 mm. The shoulder portion lateral side groove 40 is configured such that the depth from an opening portion on the shoulder portion 6 side to the groove bottom 41 in the groove width direction is deeper than the depth from an opening portion on the non-contact rib 50 side to the groove bottom 41, and the groove depth Ds specified herein is the depth from the opening portion on the non-contact rib 50 side to the groove bottom 41.

The circumferential reinforcing layer 145 of the belt layer 14 is formed such that the distance from the shoulder portion lateral side groove 40 is within a predetermined range. Specifically, for the circumferential reinforcing layer 145 and the shoulder portion lateral side groove 40, when the development width of the tread ground contact surface 3 of the tread portion 2 is denoted as W₀, and the distance between the end portion 145a of the circumferential reinforcing layer 145 in the tire width direction and the groove bottom 41 of the shoulder portion lateral side groove 40 is denoted as W₁, the development width W₀ and the distance W₁ satisfy the relationship 0.06×W₀≤W₁≤0.28×W₀.

The relationship between the development width W₀ and the distance W₁ is preferably within the range of 0.10×W₀≤W₁≤0.24×W₀. Additionally, the circumferential reinforcing layer 145 is configured such that a width We of the circumferential reinforcing layer 145 in the tire width direction is within the range of 0.5×W₀≤Wc≤0.9×W₀ with respect to the development width W₀ of the tread ground contact surface 3.

The development width W₀ referred to here is a developed dimension between ground contact edges T on both sides of the tread ground contact surface 3 in the tire width direction. The ground contact edge T is defined as a maximum width position in the tire width direction of the contact surface between the pneumatic tire 1 and a flat plate when the pneumatic tire 1 is mounted on a specified rim, inflated to a specified internal pressure, placed perpendicular to the flat plate, and applied with a load corresponding to a specified load. In the present embodiment, the ground contact edge T is substantially at the same position as the shoulder portion 6.

“Specified rim” refers to a “standard rim” defined by the Japan Automobile Tyre Manufacturers Association, Inc. (JATMA), a “Design Rim” defined by the Tire and Rim Association, Inc. (TRA), or a “Measuring Rim” defined by the European Tyre and Rim Technical Organisation (ETRTO). “Specified internal pressure” refers to a “maximum air pressure” specified by JATMA, the maximum value in “TIRE LOAD LIMITS AT VARIOUS COLD INFLATION PRESSURES” specified by TRA, or “INFLATION PRESSURES” specified by ETRTO. A specified load refers to a “maximum load capacity” specified by JATMA, the maximum value in “TIRE LOAD LIMITS AT VARIOUS COLD INFLATION PRESSURES” specified by TRA, or “LOAD CAPACITY” specified by ETRTO.

Additionally, the distance W₁ between the end portion 145a of the circumferential reinforcing layer 145 and the groove bottom 41 of the shoulder portion lateral side groove 40, as well as the width We of the circumferential reinforcing layer 145, are measured in a tire meridian cross-section in an unloaded state with the tire mounted on a specified rim and filled with a specified internal pressure. The same applies to all dimensions in the following description.

Additionally, the position of the end portion 145a of the circumferential reinforcing layer 145 in the tire width direction is located on the outer side in the tire width direction relative to the shoulder main groove 22, which is the circumferential main groove 20 located outermost in the tire width direction among the plurality of circumferential main grooves 20. Therefore, in the tire width direction, the end portion 145a of the circumferential reinforcing layer 145 is located within the range in the tire width direction where the shoulder land portion 33, which is the land portion 30 located outermost in the tire width direction among the plurality of land portions 30, is disposed. As such, the end portion 145a of the circumferential reinforcing layer 145, located within the range in the tire width direction where the shoulder land portion 33 is disposed, satisfies the relationship 0.60≤W₁/W₄≤0.95, where W₁ is the distance between the end portion 145a of the circumferential reinforcing layer 145 and the groove bottom 41 of the shoulder portion lateral side groove 40, and W₄ is the width of the shoulder land portion 33 in the tire width direction.

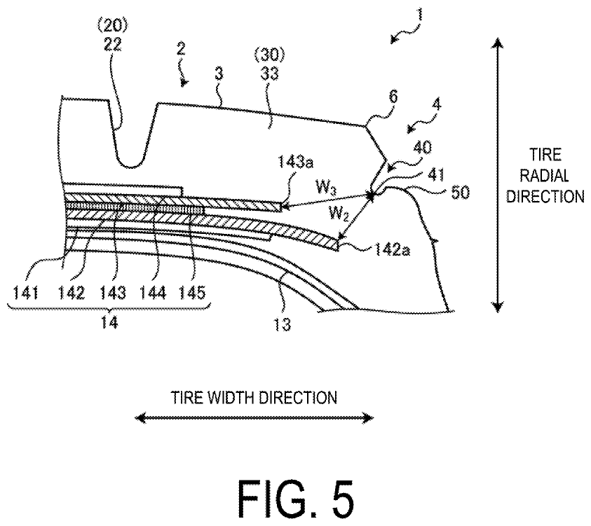

FIG. 5 is an explanatory diagram showing the positional relationship between the cross belt layers 142 and 143 of the belt layer 14 and the shoulder portion lateral side groove 40. The shoulder portion lateral side groove 40 disposed on the shoulder portion lateral side surface 4 is configured such that the distance W₂ between the end portion 142a in the tire width direction of the inner cross belt layer 142, which is disposed on the inner side in the tire radial direction of the circumferential reinforcing layer 145 among the pair of cross belt layers 142 and 143 of the belt layer 14, and the groove bottom 41 of the shoulder portion lateral side groove 40 is within the range of 7 mm≤W₂≤25 mm. Additionally, the distance W₃ between the end portion 143a in the tire width direction of the outer cross belt layer 143, which is disposed on the outer side in the tire radial direction of the circumferential reinforcing layer 145 among the pair of cross belt layers 142 and 143 of the belt layer 14, and the groove bottom 41 of the shoulder portion lateral side groove 40 is within the range of 10 mm≤W₃≤30 mm.

The distance W₂ between the end portion 142a of the inner cross belt layer 142 and the groove bottom 41 of the shoulder portion lateral side groove 40 is preferably within the range of 10 mm≤W₂≤22 mm, and the distance W₃ between the end portion 143a of the outer cross belt layer 143 and the groove bottom 41 of the shoulder portion lateral side groove 40 is preferably within the range of 13 mm≤W₃≤27 mm.

When mounting the pneumatic tire 1 according to the present embodiment to a vehicle, the pneumatic tire 1 is mounted on a rim wheel and inflated with air inside to an inflated state, and then mounted to the vehicle. When the vehicle on which the pneumatic tires 1 are mounted travels, the pneumatic tire 1 rotates with a lower portion of the tread ground contact surface 3 of the tread portion 2 in contact with a road surface. When the vehicle on which the pneumatic tires 1 are mounted travels on a dry road surface, the vehicle travels mainly by transmitting a driving force and a braking force to the road surface and generating a turning force by friction forces between the tread ground contact surface 3 and the road surface.

During traveling on a wet road surface, water between the tread ground contact surface 3 and the road surface enters grooves such as the circumferential main grooves 20, and the vehicle travels while the water between the tread ground contact surface 3 and the road surface is drained by the grooves. This allows the tread ground contact surface 3 to easily contact the road surface and allows the vehicle to travel by the friction force between the tread ground contact surface 3 and the road surface.

When a vehicle equipped with the pneumatic tire 1 travels, the tread ground contact surface 3 contacts the road surface, causing loads such as the vehicle's weight to act on the tread portion 2. The load acting on the tread portion 2 varies depending on the vehicle's running condition. During straight travel, the load tends to act primarily around the tire equatorial plane CL of the tread portion 2, while during cornering or lane changes, a large load tends to act near the shoulder portion 6. In particular, during cornering, the load tends to act on the pneumatic tire 1 located on the outer side in the radial direction of the cornering among the pneumatic tires 1 positioned on both sides in the vehicle width direction, and further, the load tends to act near the shoulder portion 6 of that pneumatic tire 1. Therefore, a large load tends to act near the shoulder portion 6 during cornering.

As described above, a large load tends to act near the shoulder portion 6, but the shoulder portion lateral side groove 40 is disposed on the inner side in the tire radial direction of the shoulder portion 6. Therefore, when a load acts on the shoulder portion 6, the area near the shoulder portion 6 of the tread portion 2 is prone to deformation. In other words, when a large load acts near the shoulder portion 6, a force directed toward the inner side in the tire radial direction acts on the area near the shoulder portion 6. Since the shoulder portion lateral side groove 40 is located in the direction in which this force acts relative to the shoulder portion 6, the groove width of the shoulder portion lateral side groove 40 deforms in a narrowing direction when a load acts on the shoulder portion 6. This disperses the load acting near the shoulder portion 6 of the tread portion 2, making it difficult for a locally large load to act. As a result, uneven wear, in which only the area near the shoulder portion 6 wears significantly due to a large load acting near the shoulder portion 6 of the tread portion 2 during vehicle travel, can be suppressed.

Additionally, during braking or driving while the vehicle is traveling, a relative force in the tire circumferential direction acts on the pneumatic tire 1 between the portion closer to the inner side in the tire radial direction and the portion closer to the outer side in the tire radial direction. Therefore, for example, on the shoulder portion lateral side surface 4 where the shoulder portion lateral side groove 40 is disposed, a relative force in the tire circumferential direction acts between the portion on the shoulder portion 6 side and the portion on the non-contact rib 50 side, with the shoulder portion lateral side groove 40 as the boundary. As a result, a shear force, which is a force in opposite directions in the tire circumferential direction, acts on the shoulder portion lateral side groove 40 between the portion on the shoulder portion 6 side and the portion on the non-contact rib 50 side.

When a shear force in the tire circumferential direction acts on the shoulder portion lateral side groove 40, the shear force makes it likely for cracks to occur at the groove bottom 41 of the shoulder portion lateral side groove 40. In other words, due to the shear force in the tire circumferential direction acting on both sides in the groove width direction of the shoulder portion lateral side groove 40 in the tread portion 2, strain occurs near the groove bottom 41 of the shoulder portion lateral side groove 40 in the tread portion 2. The shoulder portion lateral side groove 40 is prone to crack formation at the groove bottom 41 due to the strain occurring near the groove bottom 41 of the shoulder portion lateral side groove 40 in the tread portion 2.

In contrast, in the pneumatic tire 1 according to the present embodiment, the belt layer 14 includes the circumferential reinforcing layer 145 that is formed with a width in the tire width direction narrower than the width of the pair of cross belt layers 142 and 143, and in which the inclination angle of the belt cords is 5° or less. This allows the circumferential reinforcing layer 145 to improve the rigidity in the tire circumferential direction near the groove bottom 41 of the shoulder portion lateral side groove 40 in the tread portion 2. Therefore, even when a shear force in the tire circumferential direction acts on both sides in the groove width direction of the shoulder portion lateral side groove 40 during vehicle travel, the strain near the groove bottom 41 of the shoulder portion lateral side groove 40 in the tread portion 2 can be suppressed, and cracks occurring at the groove bottom 41 of the shoulder portion lateral side groove 40 can be suppressed.

Additionally, when a vehicle mounted with the pneumatic tires 1 travels with the tread ground contact surface 3 in contact with the road surface, the tread portion 2 gradually wears from the tread ground contact surface 3 side in the land portion 30. At this time, a portion of the tread ground contact surface 3 near the center in the tire width direction is likely to increase in outer diameter due to centrifugal force during rotation of the pneumatic tire 1, and is likely to come into contact with the ground with a large ground contact pressure.

On the other hand, the portion of the tread ground contact surface 3 near the end portion in the tire width direction is likely to decrease in ground contact pressure during straight travel due to a difference in outer diameter relative to the portion at or near the center in the tire width direction. In other words, while a large load tends to act near the shoulder portion 6 of the tread portion 2 during vehicle cornering, the ground contact pressure near the shoulder portion 6 tends to be lower compared to the portion near the center in the tire width direction during straight travel. Therefore, in the portion of the tread ground contact surface 3 near the end portion in the tire width direction, slippage is likely to occur between the tread ground contact surface 3 and the road surface during straight travel due to a difference in ground contact pressure caused by the difference in outer diameter relative to the portion near the center in the tire width direction during rotation of the pneumatic tire 1, and wear is relatively likely to occur. The tread ground contact surface 3 is likely to be unevenly worn because the portion at or near the center and the portion at or near the end portion in the tire width direction are different in susceptibility to wear during straight travel.

In contrast, in the pneumatic tire 1 according to the present embodiment, since the belt layer 14 includes the circumferential reinforcing layer 145, the belt layer 14 can suppress elongation in the tire circumferential direction in the range where the circumferential reinforcing layer 145 is disposed in the tire width direction by means of the circumferential reinforcing layer 145. This allows the circumferential reinforcing layer 145 to suppress an increase in the outer diameter during rotation of the pneumatic tire 1, thereby preventing the area near the shoulder portion 6 of the tread ground contact surface 3 from becoming more prone to wear compared to the portion near the center in the tire width direction due to the increase in the outer diameter of the portion near the center in the tire width direction during rotation of the pneumatic tire 1, and thus suppressing the occurrence of uneven wear during straight travel.

Additionally, since the development width W₀ of the tread ground contact surface 3 of the tread portion 2 and the distance W₁ between the end portion 145a of the circumferential reinforcing layer 145 and the groove bottom 41 of the shoulder portion lateral side groove 40 satisfy the relationship 0.06×W₀≤W₁≤0.28×W₀, improved crack resistance and uneven wear resistance can be provided in a well-balanced manner. In other words, if the relationship between the development width W₀ and the distance W₁ is W₁<0.06×W₀, the distance W₁ to the groove bottom 41 of the shoulder portion lateral side groove 40 is too small, which may result in an excessively small volume of the tread rubber 5 in the portion between the groove bottom 41 of the shoulder portion lateral side groove 40 and the circumferential reinforcing layer 145 in the tread portion 2. In this case, it becomes difficult to ensure the rigidity near the groove bottom 41 of the shoulder portion lateral side groove 40 in the tread portion 2, which may make it difficult to suppress cracks occurring at the groove bottom 41 of the shoulder portion lateral side groove 40.

Additionally, if the relationship between the development width W₀ and the distance W₁ is W₁>0.28×W₀, the distance W₁ to the groove bottom 41 of the shoulder portion lateral side groove 40 is too large, which may make it difficult to improve the rigidity near the groove bottom 41 of the shoulder portion lateral side groove 40 in the tread portion 2 by means of the circumferential reinforcing layer 145, even if the circumferential reinforcing layer 145 is included in the belt layer 14. In this case, it becomes difficult to suppress strain near the groove bottom 41 of the shoulder portion lateral side groove 40 in the tread portion 2 by means of the circumferential reinforcing layer 145, which may make it difficult to suppress cracks occurring at the groove bottom 41 of the shoulder portion lateral side groove 40. Furthermore, if the relationship between the development width W₀ and the distance W₁ is W₁>0.28×W₀, the distance W₁ to the groove bottom 41 of the shoulder portion lateral side groove 40 is too large, which may result in an excessively narrow width of the circumferential reinforcing layer 145 in the tire width direction. In this case, it is difficult to suppress the increase in the outer diameter at or near the center in the tire width direction by the circumferential reinforcing layer 145 during the rotation of the pneumatic tire 1, and thus, there is a risk that it is difficult to suppress the occurrence of uneven wear during straight travel caused by the increase in the outer diameter at or near the center in the tire width direction during rotation of the pneumatic tire 1.

In contrast, if the relationship between the development width W₀ and the distance W₁ is within the range of 0.06×W₀≤W₁≤0.28×W₀, the rigidity near the groove bottom 41 of the shoulder portion lateral side groove 40 in the tread portion 2 can be appropriately improved by the circumferential reinforcing layer 145 without becoming too low, and the increase in the outer diameter of the portion near the center in the tire width direction during rotation of the pneumatic tire 1 can be suppressed by the circumferential reinforcing layer 145. This makes it possible to suppress cracks occurring at the groove bottom 41 of the shoulder portion lateral side groove 40 while also preventing the area near the shoulder portion 6 of the tread ground contact surface 3 from wearing earlier than the portion near the center in the tire width direction during straight travel. As a result, improved crack resistance and uneven wear resistance can be provided in a well-balanced manner.

Additionally, since the pair of cross belt layers 142 and 143 are configured such that the distance W₂ between the end portion 142a of the inner cross belt layer 142 in the tire width direction and the groove bottom 41 of the shoulder portion lateral side groove 40 is within the range of 7 mm≤W₂≤25 mm, and the distance W₃ between the end portion 143a of the outer cross belt layer 143 in the tire width direction and the groove bottom 41 of the shoulder portion lateral side groove 40 is within the range of 10 mm≤W₃≤30 mm, crack resistance can be more reliably improved.

In other words, if the distance W₂ between the end portion 142a of the inner cross belt layer 142 and the groove bottom 41 of the shoulder portion lateral side groove 40 is W₂<7 mm, or if the distance W₃ between the end portion 143a of the outer cross belt layer 143 and the groove bottom 41 of the shoulder portion lateral side groove 40 is W₃<10 mm, the distance between the inner cross belt layer 142 or the outer cross belt layer 143 and the groove bottom 41 of the shoulder portion lateral side groove 40 is too small, which may result in an excessively small volume of the tread rubber 5 in the portion between the groove bottom 41 of the shoulder portion lateral side groove 40 and the cross belt layers 142 and 143 in the tread portion 2. In this case, it becomes difficult to ensure the rigidity near the groove bottom 41 of the shoulder portion lateral side groove 40 in the tread portion 2, which may make it difficult to suppress cracks occurring at the groove bottom 41 of the shoulder portion lateral side groove 40.

Additionally, if the distance W₂ between the end portion 142a of the inner cross belt layer 142 and the groove bottom 41 of the shoulder portion lateral side groove 40 is W₂>25 mm, or if the distance W₃ between the end portion 143a of the outer cross belt layer 143 and the groove bottom 41 of the shoulder portion lateral side groove 40 is W₃>30 mm, the distance between the inner cross belt layer 142 or the outer cross belt layer 143 and the groove bottom 41 of the shoulder portion lateral side groove 40 is too large, which may make it difficult to ensure the rigidity near the groove bottom 41 of the shoulder portion lateral side groove 40 in the tread portion 2 by means of the inner cross belt layer 142 or the outer cross belt layer 143. In this case, it becomes difficult to suppress strain near the groove bottom 41 of the shoulder portion lateral side groove 40 in the tread portion 2 by means of the inner cross belt layer 142 or the outer cross belt layer 143, which may make it difficult to suppress cracks occurring at the groove bottom 41 of the shoulder portion lateral side groove 40.

In contrast, when the distance W₂ between the end portion 142a of the inner cross belt layer 142 and the groove bottom 41 of the shoulder portion lateral side groove 40 is within the range of 7 mm≤W₂≤25 mm, and the distance W₃ between the end portion 143a of the outer cross belt layer 143 and the groove bottom 41 of the shoulder portion lateral side groove 40 is within the range of 10 mm≤W₃≤30 mm, the strain near the groove bottom 41 of the shoulder portion lateral side groove 40 in the tread portion 2 can be suppressed by the inner cross belt layer 142 and the outer cross belt layer 143 while appropriately ensuring the rigidity near the groove bottom 41 of the shoulder portion lateral side groove 40. As a result, improved crack resistance can be more reliably provided.

Additionally, since the width W₄ of the shoulder land portion 33 in the tire width direction and the distance W₁ between the end portion 145a of the circumferential reinforcing layer 145 and the groove bottom 41 of the shoulder portion lateral side groove 40 satisfy the relationship 0.60≤W₁/W₄≤0.95, improved crack resistance and uneven wear resistance can be more reliably provided in a well-balanced manner. In other words, if the relationship between the width W₄ of the shoulder land portion 33 and the distance W₁ between the end portion 145a of the circumferential reinforcing layer 145 and the groove bottom 41 of the shoulder portion lateral side groove 40 is W₁/W₄<0.60, the distance W₁ between the end portion 145a of the circumferential reinforcing layer 145 and the groove bottom 41 of the shoulder portion lateral side groove 40 relative to the width W₄ of the shoulder land portion 33 is too small, which may result in an excessively small volume of the tread rubber 5 in the portion between the groove bottom 41 of the shoulder portion lateral side groove 40 and the circumferential reinforcing layer 145. In this case, it becomes difficult to ensure the rigidity near the groove bottom 41 of the shoulder portion lateral side groove 40 in the tread portion 2, which may make it difficult to suppress cracks occurring at the groove bottom 41 of the shoulder portion lateral side groove 40.

Additionally, if the relationship between the width W₄ of the shoulder land portion 33 and the distance W₁ between the end portion 145a of the circumferential reinforcing layer 145 and the groove bottom 41 of the shoulder portion lateral side groove 40 is W₁/W₄>0.95, the distance W₁ between the end portion 145a of the circumferential reinforcing layer 145 and the groove bottom 41 of the shoulder portion lateral side groove 40 relative to the width W₄ of the shoulder land portion 33 is too large, which may result in the rigidity of the shoulder land portion 33 becoming too low compared to the rigidity of the other land portions 30. In this case, the wear of the shoulder land portion 33 during vehicle travel is likely to become larger compared to the wear of the other land portions 30, which may make it difficult to suppress shoulder uneven wear, which is uneven wear where the shoulder land portion 33 wears earlier.

In contrast, if the relationship between the width W₄ of the shoulder land portion 33 and the distance W₁ between the end portion 145a of the circumferential reinforcing layer 145 and the groove bottom 41 of the shoulder portion lateral side groove 40 is within the range of 0.60≤W₁/W₄≤0.95, it is possible to prevent the rigidity near the groove bottom 41 of the shoulder portion lateral side groove 40 in the tread portion 2 from becoming too low, while ensuring the rigidity of the shoulder land portion 33 by means of the circumferential reinforcing layer 145, thereby reducing the rigidity difference between the shoulder land portion 33 and the other land portions 30. As a result, improved crack resistance and uneven wear resistance can be more reliably provided in a well-balanced manner.

Additionally, since the angle θ of the groove wall 42 located on the inner side in the tire width direction of the shoulder portion lateral side groove 40 with respect to the tire radial direction is within the range of 0°≤θ≤50°, crack resistance can be more reliably improved. In other words, if the angle θ of the groove wall 42 of the shoulder portion lateral side groove 40 with respect to the tire radial direction is θ>50°, there is a risk that the strain in the shoulder portion lateral side groove 40 may become large when a force in the tire width direction acts on the tread portion 2, such as during vehicle cornering. In this case, the large strain occurring in the shoulder portion lateral side groove 40 may make it likely for cracks to occur at the groove bottom 41 of the shoulder portion lateral side groove 40.

In contrast, when the angle θ of the groove wall 42 of the shoulder portion lateral side groove 40 with respect to the tire radial direction is within the range of 0°≤θ≤50°, it is possible to suppress the strain in the shoulder portion lateral side groove 40 from becoming large due to a force in the tire width direction, even when such a force in the tire width direction acts on the tread portion 2. This makes it possible to suppress the occurrence of cracks at the groove bottom 41 of the shoulder portion lateral side groove 40 due to large strain in the shoulder portion lateral side groove 40. As a result, improved crack resistance can be more reliably provided.

Additionally, since the circumferential reinforcing layer 145 has a number of ends of the belt cords in the range of 15 ends per 50 mm or more and 30 ends per 50 mm or less, crack resistance and uneven wear resistance can be more reliably improved in a well-balanced manner. That is, if the number of ends of the belt cords of the circumferential reinforcing layer 145 is less than 15 ends per 50 mm, the number of ends of the belt cords is excessively small, and thus, there is a risk that it is difficult to ensure the rigidity of the circumferential reinforcing layer 145, which may make it difficult to appropriately improve the rigidity near the center in the tire width direction by means of the circumferential reinforcing layer 145. In this case, it is difficult to suppress the increase in the outer diameter at or near the center in the tire width direction by the circumferential reinforcing layer 145 during the rotation of the pneumatic tire 1, and thus, there is a risk that it is difficult to suppress the occurrence of uneven wear at or near the shoulder portion 6 during straight travel caused by the increase in the outer diameter at or near the center in the tire width direction. If the number of ends of the belt cords of the circumferential reinforcing layer 145 is more than 30 ends per 50 mm, the number of ends of the belt cords is excessively large, and thus, there is a risk that the rigidity of the circumferential reinforcing layer 145 becomes excessively large. In this case, the rigidity difference between the rigidity of the circumferential reinforcing layer 145 and the rigidity of the tread rubber 5 surrounding the circumferential reinforcing layer 145 is likely to become large, which may cause increased strain near the groove bottom 41 of the shoulder portion lateral side groove 40 due to the rigidity difference, making it difficult to suppress cracks originating from the groove bottom 41.

In contrast, when the number of ends of the belt cords of the circumferential reinforcing layer 145 is within the range of 15 ends per 50 mm or more and 30 ends per 50 mm or less, the rigidity of the circumferential reinforcing layer 145 is ensured, and the rigidity difference between the circumferential reinforcing layer 145 and the tread rubber 5 can be suppressed from becoming excessively large. This makes it possible to suppress uneven wear in which the area near the shoulder portion 6 of the tread portion 2 wears earlier than the portion near the center in the tire width direction during straight travel, while also suppressing the occurrence of cracks due to strain near the groove bottom 41 of the shoulder portion lateral side groove 40. As a result, improved crack resistance and uneven wear resistance can be more reliably provided in a well-balanced manner.

### Modified Examples

In the above-described embodiment, the number of circumferential main grooves 20 disposed in the tread portion 2 is four, but the number of circumferential main grooves 20 may be other than four. The circumferential main grooves 20 disposed in the tread portion 2 may be three or fewer, or five or more.

In the embodiment described above, although the pneumatic tire 1 is used for description as an example of the tire according to the embodiment of the present technology, the tire according to the embodiment of the present technology may be a tire other than the pneumatic tire 1. The tire according to the embodiment of the present technology may be, for example, a so-called airless tire that can be used without filling a gas.

### Examples

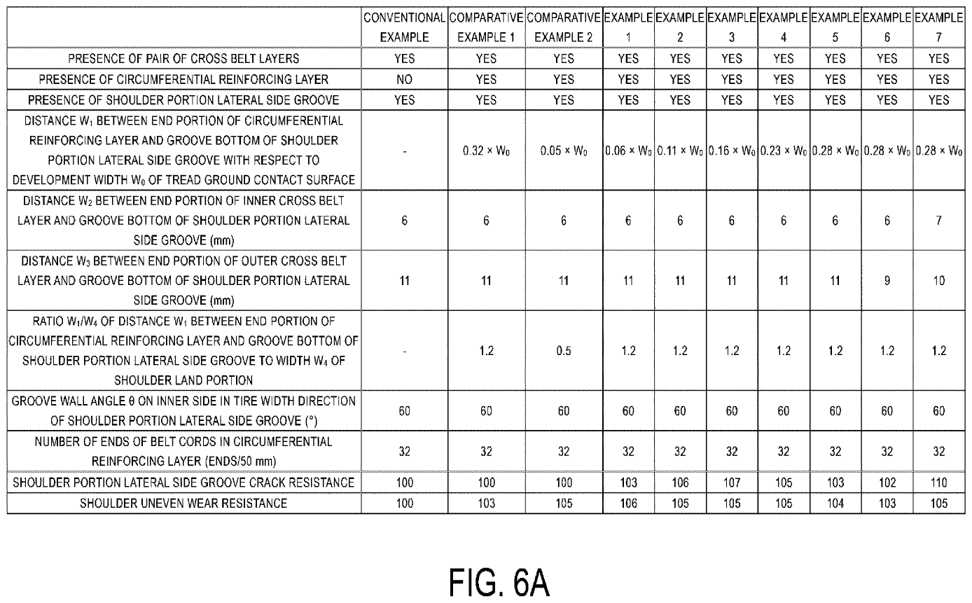

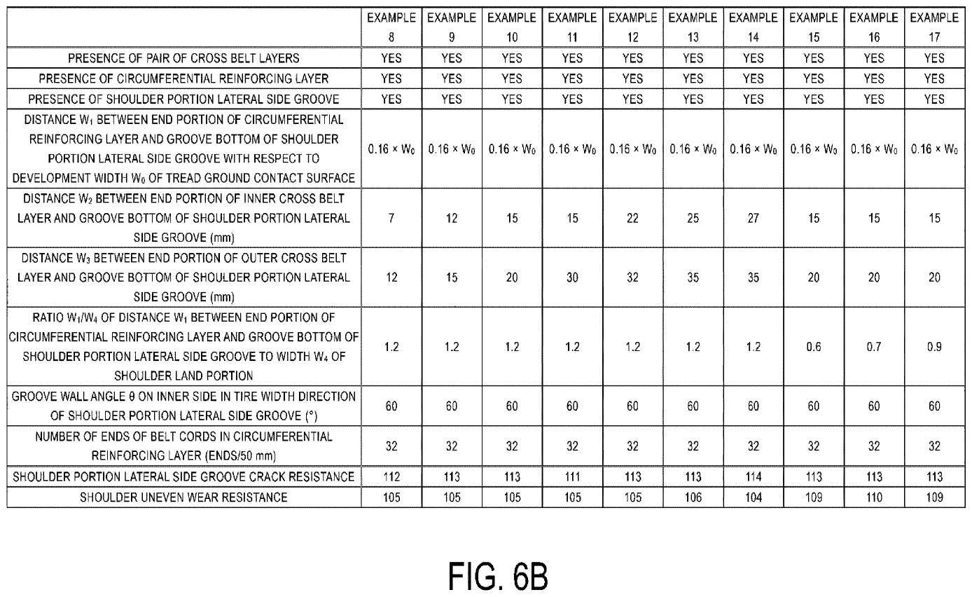

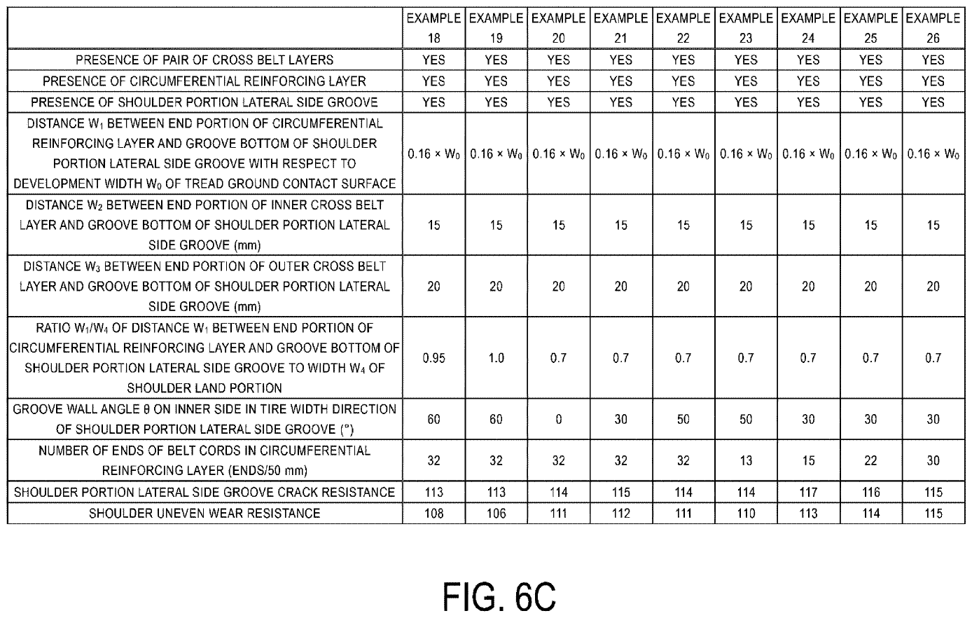

FIGS. 6A to 6C are tables indicating results of performance evaluation tests of pneumatic tires. In relation to the pneumatic tire 1 described above, description will be given of performance evaluation tests conducted on a pneumatic tire according to Conventional Example, the pneumatic tires 1 according to embodiments of the present technology, and pneumatic tires according to Comparative Examples to be compared with pneumatic tires 1 according to the embodiments of the present technology. For performance evaluation tests, tests on shoulder portion lateral side groove crack resistance and shoulder uneven wear resistance were conducted.

The performance evaluation tests were conducted by mounting the pneumatic tires 1, having a tire nominal size of 295/75R22.5 as specified by TRA, on rim wheels of regular rims specified by TRA, adjusting the air pressure to the maximum air pressure specified by TRA, and mounting the rim wheels on a 2-DD test vehicle (tractor head) to perform test traveling.

The evaluation method for each test item was as follows: for shoulder portion lateral side groove crack resistance, after running the test vehicle equipped with the test tire for 100,000 km, the degree of crack occurrence at the groove bottom 41 of the shoulder portion lateral side groove 40 was measured, and the measured degree of crack occurrence was evaluated by expressing it as an index value with the value of Conventional Example described below being 100. For shoulder portion lateral side groove crack resistance, a larger index value indicates a lower degree of crack occurrence at the groove bottom 41 of the shoulder portion lateral side groove 40, indicating excellent shoulder portion lateral side groove crack resistance.

For shoulder uneven wear resistance, after traveling 100,000 km with the test vehicle mounted with the test tires, the degree of occurrence of shoulder uneven wear, which is uneven wear of the shoulder land portion 33 relative to the center land portion 31 and the middle land portion 32, was measured, and the measured degree of occurrence of shoulder uneven wear was evaluated by expressing it as an index value with the value of Conventional Example described below being 100. The shoulder uneven wear resistance indicates that the larger the index value, the smaller the degree of occurrence of shoulder uneven wear, indicating excellent shoulder uneven wear resistance.

The performance evaluation tests were performed on twenty nine types of pneumatic tires that are a pneumatic tire of Conventional Example as an example of a conventional pneumatic tire, pneumatic tires of Examples 1 to 26 corresponding to the pneumatic tire 1 according to an embodiment of the present technology, and pneumatic tires of Comparative Examples 1 and 2 compared with the pneumatic tire 1 according to an embodiment of the present technology. Among these, the pneumatic tire of Conventional Example has the shoulder portion lateral side groove but does not have the circumferential reinforcing layer. Additionally, the pneumatic tires of Comparative Examples 1 and 2 do not satisfy the relationship 0.06×W₀≤W₁≤0.28×W₀, where W₀ is the development width of the tread ground contact surface and W₁ is the distance between the end portion of the circumferential reinforcing layer and the groove bottom of the shoulder portion lateral side groove.

In contrast, Examples 1 to 26, which are examples of the pneumatic tire 1 according to the present technology, all have the circumferential reinforcing layer 145 and the shoulder portion lateral side groove 40, and satisfy the relationship 0.06×W₀≤W₁≤0.28×W₀, where W₀ is the development width of the tread ground contact surface 3 and W₁ is the distance between the end portion 145a of the circumferential reinforcing layer 145 and the groove bottom 41 of the shoulder portion lateral side groove 40. Furthermore, the pneumatic tires 1 of Examples 1 to 26 differ in the distance W₂ (mm) between the end portion 142a of the inner cross belt layer 142 and the groove bottom 41 of the shoulder portion lateral side groove 40, the distance W₃ (mm) between the end portion 143a of the outer cross belt layer 143 and the groove bottom 41 of the shoulder portion lateral side groove 40, the ratio W₁/W₄ of the width W₄ of the shoulder land portion 33 to the distance W₁, the angle θ of the inner groove wall 42 in the tire width direction of the shoulder portion lateral side groove 40, and the number of ends of the belt cords (ends per 50 mm) of the circumferential reinforcing layer 145.

As a result of conducting evaluation tests using these pneumatic tires 1, as illustrated in FIG. 6A to FIG. 6C, it was found that the pneumatic tires 1 of Examples 1 to 26 could improve both shoulder portion lateral side groove crack resistance and shoulder uneven wear resistance compared to the Conventional Example. In other words, the pneumatic tires 1 of Examples 1 to 26 can improve crack resistance and uneven wear resistance in a well-balanced manner.

The present disclosure includes the following technologies.

### Technology [1]

A tire including a belt layer that is disposed in a tread portion and includes a plurality of belt plies,
the belt layer including
a pair of cross belt layers in which inclination directions of belt cords in a tire width direction relative to a tire circumferential direction are opposite to each other, and
a circumferential reinforcing layer disposed between the pair of cross belt layers, formed with a width in the tire width direction narrower than a width of the cross belt layers, and having a belt cord inclination angle in the tire width direction relative to the tire circumferential direction of 5° or less,
in the tread portion, a shoulder portion lateral side groove extending in the tire circumferential direction being disposed on a shoulder portion lateral side surface, the shoulder portion lateral side surface being a side surface of the tread portion in the tire width direction, and
when a development width of a tread ground contact surface of the tread portion is denoted as W₀ and a distance between an end portion of the circumferential reinforcing layer in the tire width direction and a groove bottom of the shoulder portion lateral side groove is denoted as W₁, the development width W₀ and the distance W₁ satisfying a relationship of 0.06×W₀≤W₁≤0.28×W₀.

### Technology [2]

The tire according to Technology [1], wherein, when a distance between an end portion in the tire width direction of the cross belt layer disposed on an inner side in a tire radial direction of the circumferential reinforcing layer among the pair of cross belt layers and the groove bottom of the shoulder portion lateral side groove is denoted as W₂, and a distance between an end portion in the tire width direction of the cross belt layer disposed on an outer side in the tire radial direction of the circumferential reinforcing layer among the pair of cross belt layers and the groove bottom of the shoulder portion lateral side groove is denoted as W₃, the distance W₂ is within a range of 7 mm≤W₂≤25 mm, and the distance W₃ is within a range of 10 mm≤W₃≤30 mm.

### Technology [3]

The tire according to Technology [1] or Technology [2], wherein the tread portion is provided with at least two or more circumferential main grooves extending in the tire circumferential direction and a plurality of land portions defined by the circumferential main grooves, and when a width in the tire width direction of a shoulder land portion, the shoulder land portion being the land portion located outermost in the tire width direction among the plurality of land portions, is denoted as W₄, the width W₄ of the shoulder land portion and the distance W₁ satisfy a relationship of 0.60≤W₁/W₄≤0.95.

### Technology [4]

The tire according to any one of Technology [1] to Technology [3], wherein the shoulder portion lateral side groove has an angle θ of a groove wall located on an inner side in the tire width direction with respect to a tire radial direction within a range of 0° ≤θ≤50°.

### Technology [5]

The tire according to any one of Technology [1] to Technology [4], wherein the belt cords of the circumferential reinforcing layer are made of steel wire, and the number of ends of the belt cords of the circumferential reinforcing layer is within a range of 15 ends per 50 mm or more and 30 ends per 50 mm or less.

1. A tire comprising a belt layer that is disposed in a tread portion and comprises a plurality of belt plies,
the belt layer comprising
a pair of cross belt layers in which inclination directions of belt cords in a tire width direction relative to a tire circumferential direction are opposite to each other, and
a circumferential reinforcing layer disposed between the pair of cross belt layers, formed with a width in the tire width direction narrower than a width of the cross belt layers, and having a belt cord inclination angle in the tire width direction relative to the tire circumferential direction of 5° or less,
in the tread portion, a shoulder portion lateral side groove extending in the tire circumferential direction being disposed on a shoulder portion lateral side surface, the shoulder portion lateral side surface being a side surface of the tread portion in the tire width direction, and
a development width W₀ of a tread ground contact surface of the tread portion and a distance W₁ between an end portion of the circumferential reinforcing layer in the tire width direction and a groove bottom of the shoulder portion lateral side groove satisfying a relationship of 0.06×W₀≤W₁≤0.28×W₀.

2. The tire according to claim 1, wherein, when a distance between an end portion in the tire width direction of the cross belt layer disposed on an inner side in a tire radial direction of the circumferential reinforcing layer among the pair of cross belt layers and the groove bottom of the shoulder portion lateral side groove is denoted as W₂, and a distance between an end portion in the tire width direction of the cross belt layer disposed on an outer side in the tire radial direction of the circumferential reinforcing layer among the pair of cross belt layers and the groove bottom of the shoulder portion lateral side groove is denoted as W₃, the distance W₂ is within a range of 7 mm≤W₂≤25 mm, and the distance W₃ is within a range of 10 mm≤W₃≤30 mm.

3. The tire according to claim 1, wherein the tread portion is provided with at least two or more circumferential main grooves extending in the tire circumferential direction and a plurality of land portions defined by the circumferential main grooves, and when a width in the tire width direction of a shoulder land portion, the shoulder land portion being the land portion located outermost in the tire width direction among the plurality of land portions, is denoted as W₄, the width W₄ of the shoulder land portion and the distance W₁ satisfy a relationship of 0.60≤W₁/W₄≤0.95.

4. The tire according to claim 1, wherein the shoulder portion lateral side groove has an angle θ of a groove wall located on an inner side in the tire width direction with respect to a tire radial direction within a range of 0°≤θ≤50°.

5. The tire according to claim 1, wherein
the belt cords of the circumferential reinforcing layer are made of steel wire, and
the number of ends of the belt cords of the circumferential reinforcing layer is within a range of 15 ends per 50 mm or more and 30 ends per 50 mm or less.
